(19) United States
(12) Patent Application Publication
(10) Pub. No.: US 2025/0031596 A1
(43) Pub. Date: Jan. 30, 2025

(54) SYSTEM AND METHOD FOR IDENTIFYING BROKEN SHEAR PINS ON AN AGRICULTURAL IMPLEMENT

(71) Applicant: CNH Industrial America LLC, New Holland, PA (US)

(72) Inventors: Brittany Schroeder, Bunker Hill, IN (US); Joshua D. Knoblauch, Lowpoint, IL (US)

(21) Appl. No.: 18/227,105

(22) Filed: Jul. 27, 2023

(51) Int. Cl. A01B 61/04; A01B 35/06; G01M 13/00

(52) U.S. Cl. CPC A01B 61/042; A01B 35/06; A01B 61/046; G01M 13/00

(57) ABSTRACT

A system for identifying broken shear pins on an agricultural implement includes a plurality of shank assemblies. Each shank assembly includes an attachment structure coupling the shank assembly to the frame of the agricultural implement. Each shank assembly also includes shank pivotably coupled to the attachment structure and a shear pin extending through the attachment structure and the shank to prevent pivoting of the shank. The system also includes a first sensor configured to generate data indicative of vibrations of the frame and a second sensor configured to generate data indicative of the soil condition aft of each shank. Additionally, the system includes a computing system configured to determine when the shear pin of at least one shank assembly has failed. Furthermore, the computing system is configured to identify a location of each shank assembly with a failed shear pin.

### FIELD

The present disclosure relates generally to agricultural implements and, more particularly, to systems and methods for identifying broken shear pins on an agricultural implement.

### BACKGROUND

It is well known that, to attain the best agricultural performance from a field, a farmer must cultivate the soil, typically through a tillage operation. Modern farmers perform tillage operations by pulling a tillage implement behind an agricultural vehicle, such as a tractor. Tillage implements typically include a plurality of ground-engaging tools configured to penetrate the soil to a particular depth. In this respect, the ground-engaging tools may be pivotably coupled to a frame of the tillage implement. In many instances, biasing elements, such as springs, are used to exert biasing forces on the ground-engaging tools. This configuration allows the ground-engaging tools to be biased towards a ground-engaging position relative to the frame such that the tools have the particular depth of soil penetration as the agricultural vehicle pulls the tillage implement through the field. Additionally, this configuration permits the ground-engaging tools to pivot out of the way of rocks or other impediments in the soil, thereby preventing damage to the ground-engaging tools or other components on the implement.

In addition to such biasing elements, tillage implements often utilize a shear bolt mounting arrangement for some ground-engaging tools, such as shanks, in which shear pins or bolts are used to couple the ground-engaging tools to the frame or associated attachment structure. In such an embodiment, the shear pins protect the ground-engaging tools from excessive loading that would otherwise substantially damage or break the tools. For instance, when the adjustability provided by a biasing element is insufficient, the associated shear pin may break, thereby allowing the corresponding ground-engaging tool to pivot out of the way of rocks or other impediments in the soil.

When a shear pin breaks during the performance of an agricultural operation, the associated ground-engaging tool typically will no longer be capable of effectively working the soil. As such, a broken shear pin needs to be replaced. However, it is often difficult for the operator to determine the location of the ground-engaging tools with broken shear pins from the cab of the agricultural vehicle as the operator's view of the ground-engaging tools is often blocked by dust and debris.

Accordingly, systems and methods for identifying broken shear pins on an agricultural implement would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a system for identifying broken shear pins on an agricultural implement. The system includes a plurality of ground-engaging shank assemblies, each ground-engaging shank assembly including an attachment structure coupling the ground-engaging shank assembly to a frame of an agricultural implement. Additionally, each ground-engaging shank assembly includes a shank portion pivotably coupled to the attachment structure at a pivot joint. Furthermore, each ground-engaging shank assembly includes a shear pin at least partially extending through the attachment structure and the shank portion to prevent pivoting of the shank portion about the pivot joint. The system also includes a first sensor configured to generate data indicative of vibrations of the frame of the agricultural implement. Moreover, the system includes a second sensor configured to generate data indicative of a soil condition aft of the shank portion of each ground-engaging shank assembly relative to a direction of travel of the agricultural implement. Additionally, the system includes a computing system communicatively coupled to the first sensor and the second sensor. The computing system is configured to determine when the shear pin of at least one ground-engaging shank assembly has failed based on the first sensor data. Furthermore, after determining that the shear pin of at least one ground-engaging shank assembly has failed, the computing system is configured to identify a location of each ground-engaging shank assembly with a failed shear pin based on the second sensor data.

In another aspect, the present subject matter is directed to an agricultural implement including a frame and a plurality of ground-engaging shank assemblies supported relative to the frame. Each ground-engaging shank assembly includes an attachment structure coupling the ground-engaging shank assembly to a frame of an agricultural implement. Additionally, each ground-engaging shank assembly includes a shank portion pivotably coupled to the attachment structure at a pivot joint. Furthermore, each ground-engaging shank assembly includes a shear pin at least partially extending through the attachment structure and the shank portion to prevent pivoting of the shank portion about the pivot joint. Moreover, each ground-engaging shank assembly includes a biasing element coupled between the frame and the attachment structure, the biasing element being configured to bias the shank portion towards a ground-engaging position. The agricultural implement also includes a first sensor configured to generate data indicative of vibrations of the frame of the agricultural implement. Additionally, the agricultural implement includes a second sensor configured to generate data indicative of a soil condition aft of the shank portion of each ground-engaging shank assembly relative to a direction of travel of the agricultural implement. Furthermore, the agricultural implement includes a computing system communicatively coupled to the first sensor and the second sensor. The computing system is configured to determine when the shear pin of at least one ground-engaging shank assembly has failed based on the first sensor data. Moreover, after determining that the shear pin of the at least one ground-engaging shank assembly has failed, the computing system is configured to identify a location of at least one ground-engaging shank assembly with a failed shear pin based on the data generated by the second sensor.

In a further aspect, the present subject matter is directed to a method for identifying broken shear pins on an agricultural implement. The method includes receiving, with a computing system, first sensor data indicative of vibrations of a frame of an agricultural implement. Additionally, the method includes determining, with the computing system, when a shear pin of at least one ground-engaging shank assembly of the agricultural implement has failed based on the received first sensor data. Furthermore, the method includes receiving, with the computing system, second sensor data indicative of a soil condition aft of a shank portion of each ground-engaging shank assembly relative to a direction of travel of the agricultural implement. Moreover, the method includes initiating, with the computing system, a control action when the location of at least one ground-engaging shank assembly with a failed shear pin is identified.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural implement coupled to an agricultural vehicle in accordance with aspects of the present subject matter;

FIG. 2 illustrates another perspective view of the agricultural implement shown in FIG. 1 in accordance with aspects of the present subject matter, particularly illustrating various components of the implement:

FIG. 3 illustrates a side view of one embodiment of a shank assembly of an agricultural implement in accordance with aspects of the present subject matter:

FIG. 4 illustrates a schematic view of one embodiment of a system for identifying broken shear pins on an agricultural implement in accordance with aspects of the present subject matter:

FIG. 5 illustrates a flow diagram of one embodiment of example control logic for identifying broken shear pins on an agricultural implement in accordance with aspects of the present subject matter; and

FIG. 6 illustrates a flow diagram of one embodiment of a method for identifying broken shear pins on an agricultural implement in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and a method for identifying broken shear pins on an agricultural implement. As will be described below, the agricultural implement includes a plurality of ground-engaging shank assemblies. Each ground-engaging shank assembly, in turn, includes an attachment structure coupling the ground-engaging shank assembly to a frame of the agricultural implement. Furthermore, each ground-engaging shank assembly includes a shank portion pivotably coupled to the attachment structure at a pivot joint. Additionally, a shear pin at least partially extends through each attachment structure and the corresponding shank portion to prevent pivoting of the shank portion about the pivot joint. However, when a shear pin breaks (e.g., due to significant contact between the shank portion and an impediment in the soil), the shank portion is free to rotate relative to the attachment structure about the pivot joint.

In several embodiments, a computing system of the disclosed system is configured to determine when one or more shear pins of the implement have broken and the location(s) of such broken shear pins based on received sensor data. Specifically, in such embodiments, the computing system is configured to receive data from one or more first sensor(s) (e.g., an accelerometer(s)) mounted on the implement. Such first sensor data is, in turn, indicative of vibrations of the frame of the implement. Moreover, the computing system is configured to receive data from one or more second sensors. Such second sensor data is, in turn, configured to generate data indicative of a soil condition (e.g., a soil profile) aft of the ground-engaging shank assemblies. In this respect, the computing system is configured to determine when the shear pin of at least one ground-engaging shank assembly has failed based on the received first sensor data. For example, the computing system may be configured to determine a magnitude (e.g., amplitude) of vibrations within the frame and compare the magnitude of vibrations to a predetermined threshold such that when the magnitude exceeds the predetermined threshold, the shear pin of at least one ground-engaging shank assembly has failed. Additionally, after determining that the shear pin of at least one ground-engaging shank assembly has failed, the computing system may identify the location(s) of each ground-engaging shank assembly with a failed shear pin based on the second sensor data. For example, the computing system may be configured to determine a soil dimension profile (e.g., depth of tilled soil) aft of each ground-engaging shank assembly and compare each soil dimension profile to a soil dimension profile threshold. In this respect, when the soil dimension profile of at least one ground-engaging shank assembly falls below the threshold, the computing system identifies the location of each ground-engaging shank assembly with a failed shear pin by, for example, accessing a look-up table correlating each ground-engaging shank assembly with a soil dimension profile.

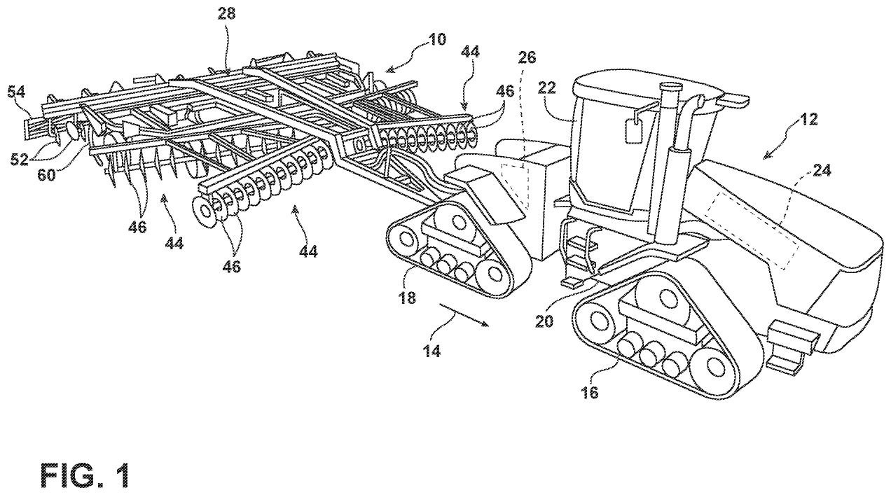

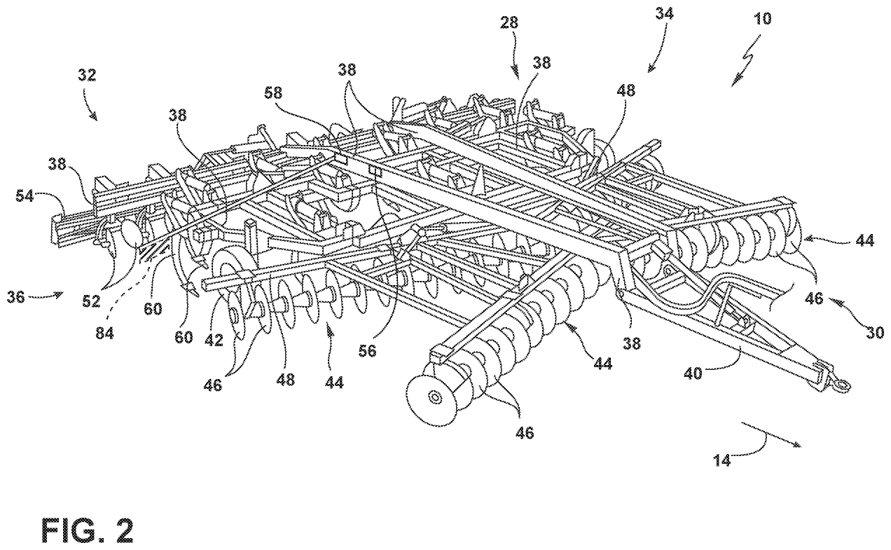

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to an agricultural vehicle 12. Additionally, FIG. 2 illustrates a perspective view of the agricultural implement 10, particularly illustrating various components of the agricultural implement 10.

In general, the agricultural implement 10 may be configured to be towed across a field in a direction of travel (e.g., as indicated by arrow 14 in FIG. 1) by the agricultural vehicle 12. As shown, the agricultural implement 10 may be configured as a tillage implement, and the agricultural vehicle 12 may be configured as an agricultural tractor. However, in other embodiments, the agricultural implement 10 may be configured as any other suitable type of implement, such as a seed-planting implement, a fertilizer-dispensing implement, and/or the like. Similarly, the agricultural vehicle 12 may be configured as any other suitable type of vehicle, such as an agricultural harvester, a self-propelled sprayer, and/or the like.

As shown in FIG. 1, the agricultural vehicle 12 may include a pair of front track assemblies 16, a pair or rear track assemblies 18, and a chassis or vehicle frame 20 coupled to and supported by the track assemblies 16, 18. Alternatively, the track assemblies 16, 18 can be replaced with tires or other suitable traction members. An operator's cab 22 may be supported by a portion of the frame 20 and may house various input devices for permitting an operator to control the operation of one or more components of the agricultural vehicle 12 and/or one or more components of the agricultural implement 10. Additionally, the agricultural vehicle 12 may include an engine 24 and a transmission 26 mounted on the vehicle frame 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown particularly in FIG. 2, the agricultural implement 10 may include an implement frame 28. The implement frame 28 may extend longitudinally between a forward end 30 and an aft end 32. The implement frame 28 may also extend laterally between a first side 34 and a second side 36. As shown in FIG. 2, the implement frame 28 generally includes a plurality of structural frame members 38, such as beams, bars, and/or the like, configured to support or couple to a plurality of components. Furthermore, a hitch assembly 40 may be coupled to the implement frame 28 and configured to couple the agricultural implement 10 to the agricultural vehicle 12. Additionally, a plurality of wheels 42 (one of which is shown in FIG. 2) may be coupled to the implement frame 28 to facilitate towing the agricultural implement 10 in the direction of travel 14.

In several embodiments, one or more ground-engaging tools may be coupled to and/or supported by the implement frame 28. More particularly, in certain embodiments, the ground-engaging tools may include one or more shank assemblies 60 and/or disc blades 46 supported relative to the implement frame 28. In one embodiment, each shank assembly 60 and/or disc blade 46 may be individually supported relative to the implement frame 28. Alternatively, the disk blades 46 may be ganged together to form one or more ganged tool assemblies, such as the disc gang assemblies 44 shown in FIGS. 1 and 2.

As illustrated in FIG. 2, each disc gang assembly 44 includes a toolbar 48 coupled to the implement frame 28 and a plurality of disc blades 46 supported by the toolbar 48 relative to the implement frame 28. Each disc blade 46 may, in turn, be configured to penetrate into or otherwise engage the soil as the agricultural implement 10 is being pulled through the field. As is generally understood, the various disc gang assemblies 44 may be oriented at an angle relative to the direction of travel 14 to promote more effective tilling of the soil.

It should be appreciated that, in addition to the shank assemblies 60 and the disc blades 46, the implement frame 28 may be configured to support any other suitable ground-engaging tools. For instance, in the illustrated embodiment, the implement frame 28 is also configured to support a plurality of leveling blades 52 and rolling (or crumbler) basket assemblies 54. In other embodiments, any other suitable ground-engaging tools may be coupled to and supported by the implement frame 28.

Furthermore, the agricultural implement 10 includes one or more first sensors 56 coupled thereto and/or supported thereon. In general, the first sensor(s) 56 is configured to generate data indicative of vibrations of the implement frame 28 of the agricultural implement 10, which may be created by the shank assembly(ies) 60 as the shank assembly(ies) 60 engage the soil during tillage operations while the agricultural implement 10 travels across the field.

In general, the first sensor(s) 56 may correspond to any suitable device(s) configured to generate data indicative of the vibrations of the implement frame 28. For example, in several embodiments, the first sensor(s) 56 may be configured as an accelerometer, inertial measurement unit (IMU), and/or the like configured to generate data indicative of the vibrations of the implement frame 28 of the agricultural implement 10. However, in alternative embodiments, the first sensor(s) 56 may be configured as any other suitable device(s) for generating data indicative of the vibrations of the implement frame 28 of the agricultural implement 10.

The agricultural implement 10 may include any number of first sensors 56 provided at any suitable locations that allows data indicative of the vibrations of the implement frame 28 of the agricultural implement 10 to be generated as the agricultural vehicle 12 and the agricultural implement 10 traverse the field. In this respect, FIG. 2 illustrates example locations for mounting the first sensor(s) 56 for generating data indicative of the vibrations of the implement frame 28 of the agricultural implement 10.

For example, as shown in FIG. 2, the first sensor 56 is mounted on one of the structural frame members 38 of the implement frame 28. In this respect, the first sensor 56 may generate data indicative of the vibrations of the implement frame 28.

However, in alternative embodiments, the first sensor(s) 56 may be installed at any other suitable location(s) that allows the device(s) to generate data indicative of the vibrations of the implement frame 28.

Likewise, the agricultural implement 10 includes one or more second sensors 58 coupled thereto and/or supported thereon. In general, the second sensor(s) 58 is configured to generate data indicative of a soil condition, such as a depth of the tilled soil or lack thereof. Specifically, in several embodiments, the second sensor(s) 58 may be provided in operative association with the shank assembly(ies) 60 of the agricultural implement 10 such that the second sensor(s) 58 has a field(s) of view 84 directed towards a portion(s) of the field disposed aft of each shank assembly 60. As such, the second sensor(s) 58 may be configured to generate data indicative of a soil condition, such as a depth of the tilled soil or lack thereof, aft of each shank assembly 60 relative to the direction of travel 14 of the agricultural implement 10 as the agricultural vehicle/implement 12/10 travels across the field.

In general, the second sensor(s) 58 may correspond to any suitable device(s) configured to generate data indicative of the soil condition aft of each shank assembly 60 relative to the direction of travel 14 of the agricultural implement 10. For example, in several embodiments, the second sensor(s) 58 may be configured as a camera, LiDAR, and/or the like configured to generate data indicative of the soil condition aft of each shank assembly 60 relative to the direction of travel 14 of the agricultural implement 10. However, in alternative embodiments, the second sensor(s) 58 may be configured as any other suitable device(s) for generating data indicative of the soil condition aft of each shank assembly 60 relative to the direction of travel 14 of the agricultural implement 10.

The agricultural implement 10 may include any number of second sensors 58 provided at any suitable locations that allows data indicative of the soil condition aft of each shank assembly 60 relative to the direction of travel 14 of the agricultural implement 10 to be generated as the agricultural vehicle 12 and the agricultural implement 10 traverse the field. In this respect, FIG. 2 illustrates example locations for mounting the second sensor(s) 58 for generating data indicative of the soil condition aft of each shank assembly of the agricultural implement 10.

For example, as shown in FIG. 2, the second sensor 58 is mounted on one of the structural frame members 38 of the implement frame 28 and directed at the portion of the field aft of the shank assemblies 60 within the field of view 84 of the second sensor(s) 58. In this respect, the second sensor 58 is configured to generate data indicative of the soil condition aft of each shank assembly 60 relative to the direction of travel 14 of the agricultural implement 10.

However, in alternative embodiments, the second sensor(s) 58 may be installed at any other suitable location(s) that allows the device(s) to generate data indicative of the soil condition aft of each shank assembly 60 of the agricultural implement 10 relative to the direction of travel 14 of the agricultural implement 10.

It should be appreciated that the configuration of the agricultural implement 10 described above and shown in FIGS. 1 and 2 is provided only to place the present subject matter in an exemplary field of use. Thus, it should be appreciated that the present subject matter may be readily adaptable to any manner of implement configuration.

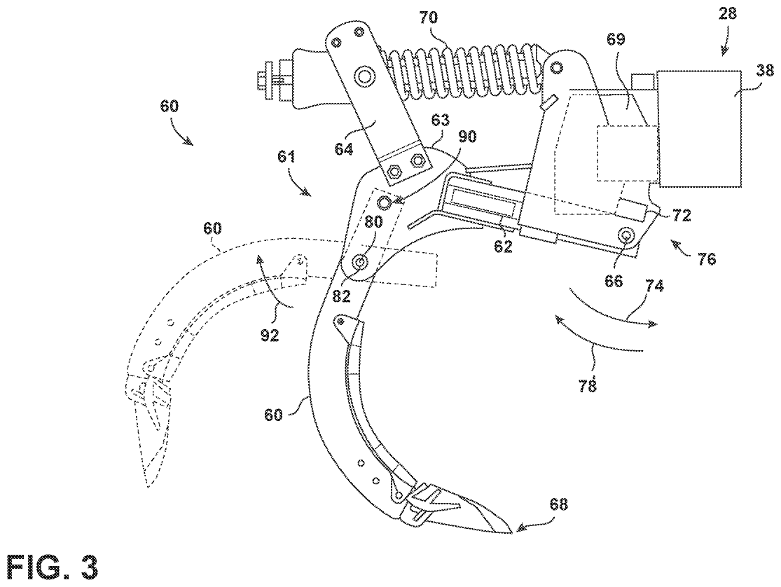

Referring now to FIG. 3, a side-view of one embodiment of a shank assembly 60 of the agricultural implement 10 described above with reference to FIGS. 1 and 2 is illustrated in accordance with aspects of the present subject matter. As shown in the illustrated embodiment, the shank assembly 60 also includes attachment structure 61 for pivotally coupling a shank 50 to the implement frame 28 (e.g., at a first pivot point 66). In one embodiment, the attachment structure 61 includes first, second, and third attachment members 62, 63, 64. For instance, as shown in FIG. 3, the first attachment member 62 is pivotably coupled to a shank base frame 69, which, in turn, is coupled to the implement frame 28 (e.g., a frame member 38 of the implement frame 28). The second attachment member 63 is coupled to the first attachment member 62 for supporting the shank 50 relative to the implement frame 28 and the third attachment member 64 is coupled to the second attachment member 63 for coupling the shank 50 to a biasing element 70 of the shank assembly 60.

Additionally, the shank assembly 60 includes the shank 50 having a tip end 68 that is configured to penetrate into or otherwise engage the ground as the agricultural implement 10 is being pulled through the field. In one embodiment, the shank 50 may be configured as a chisel. However, one of ordinary skill in the art would appreciate that the ground-engaging tool may be configured as a sweep, tine, or any other suitable ground-engaging tool. It should also be appreciated that an auxiliary attachment (not shown) may also be coupled to the shank 50 at its tip end 68, such as a point attachment.

As shown in FIG. 3, in several embodiments, the biasing element 70 may be coupled between the implement frame 28 (e.g., via the shank base frame 69) and the attachment structure 61 for the shank assembly 60 (e.g., third attachment member 64) to bias the attachment structure 61 (and, thus, the shank 50 coupled thereto) to a predetermined ground-engaging tool position (e.g., a home or base position) relative to the implement frame 28. In general, the predetermined ground-engaging tool position may correspond to a ground-engaging tool position in which the shank 50 penetrates the soil to a desired depth. In several embodiments, the predetermined ground-engaging tool position may be set by a mechanical stop 72. In operation, the biasing element 70 may permit relative movement between the attachment structure 61 and the implement frame 28. For example, the biasing element 70 may be configured to bias the attachment structure 61 to pivot relative to the implement frame 28 in a first pivot direction (e.g., as indicated by arrow 74 in FIG. 3) until an end 76 of the first attachment member 62 of the shank assembly 60 contacts the stop 72. The biasing element 70 may also allow the attachment structure to pivot away from the predetermined ground-engaging tool position (e.g., to a shallower depth of penetration), such as in a second pivot direction (e.g., as indicated by arrow 78 in FIG. 3) opposite the first pivot direction 74, when the shank 50 encounters rocks or other impediments in the field. As shown in FIG. 3, the biasing element 70 corresponds to a spring. It should be recognized, however, the biasing element 70 may be configured as an actuator or any other suitable biasing element.

As further illustrated in FIG. 3, the shank 50 may be pivotably coupled to the attachment structure 61 of the shank assembly 60 at a second pivot point 80 to allow pivoting of the shank 50 relative to the attachment structure 61 about such pivot point 80 independent of the pivotal motion of the attachment structure 61 about the first pivot point 66. More particularly, as shown in the illustrated embodiment, the shank 50 is pivotally coupled to the second attachment member 63 of the attachment structure 61 at the second pivot point 80, which, in turn, is coupled to the implement frame 28 at the first pivot point 66 via the first attachment member 62. In such an embodiment, the shank 50 may be coupled to the second attachment member 63 via an associated pivot member 82 (e.g., a pivot bolt or pin) extending through both the shank 50 and the attachment member 63 at the second pivot point 80.

Additionally, as shown in FIG. 3, the shank assembly 60 may further include a shear bolt or pin 90 (simply referred to hereinafter as a “shear pin” for simplicity purposes and without intent to limit) at least partially extending through both the second attachment member 63 and the shank 50 at a location separate from the pivot point 80 defined between such components. For instance, in the illustrated embodiment, the shear pin 90 is positioned above the pivot point 80 defined between the shank 50 and the adjacent attachment member 63. In general, the shear pin 90 may be configured to prevent rotation of the shank 50 relative to the attachment member 63 when the shear pin 90 is in an operable working condition or state, such as when the shear pin 90 has not sheared or otherwise failed. In one embodiment, the shear pin 90 may correspond to a mechanical pin designed such that the shear pin 90 breaks when a predetermined force is applied through the shear pin 90. For instance, the shear pin 90 may be designed to withstand normal or expected loading conditions for the shank 50 and fail when the loads applied through the pin 90 exceed or substantially exceed such normal/expected loading conditions.

During normal operation, the tip end 68 of the shank 50 may encounter impediments in the field causing the shank assembly 60 to rotate about the first pivot point 66 in the second pivot direction 78. Typically, the shank assembly 60 will pivot upwards in the second pivot direction 78 about the first pivot point 66 to clear the impediment and then will return to its home or ground-engaging position via the action of the biasing element 70. However, in certain instances, the shank assembly 60 may rotate upwardly without clearing the impediment, in which case a significant amount of force may be transmitted through the shank assembly 60. In such instances, the shear pin 90 may fracture or fail, thereby allowing the shank 50 to rotate about the second pivot point 80 relative to the attachment structure 61. For instance, the shank 50 may rotate about the second pivot point 80 (as indicated by arrow 92 in FIG. 3) to the shank position indicated by dashed lines in FIG. 3. In such instance when the shear pin 90 has fractured or failed, the implement frame 28 experiences vibrations different from the vibrations the implement frame 28 experiences during operations while the shear pin 90 is intact.

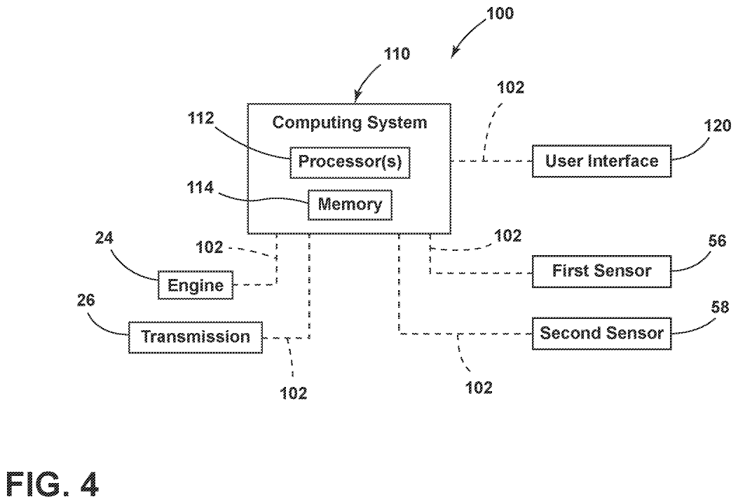

Referring now to FIG. 4, a schematic view of one embodiment of a system 100 for identifying broken shear pins on an agricultural implement is illustrated in accordance with aspects of the present subject matter. In general, the system 100 will be described herein with reference to the agricultural implement 10 described above with reference to FIGS. 1 and 2 and the shank assembly 60 described above with reference to FIG. 3. However, it should be appreciated that, in general, the disclosed system 100 may be utilized with any suitable implement having any suitable implement configuration for identifying broken shear pins on an agricultural implement. Moreover, it should be appreciated that the disclosed system 100 may be used with any other suitable ground-engaging assembly of an agricultural implement that utilizes a shear pin to prevent pivoting of such assembly during normal operating conditions.

As shown in FIG. 4, the system 100 includes a computing system 110 communicatively coupled to one or more components of the agricultural implement 10, the agricultural vehicle 12, and/or the system 100 to allow the operation of such components to be electronically or automatically controlled by the computing system 110. For instance, the computing system 110 may be communicatively coupled to the first and second sensors 56, 58 via a communicative link 102. As such, the computing system 110 may be configured to receive data from the first sensor 56 that is indicative of the vibrations of the implement frame 28 of the agricultural implement 10. Likewise, the computing system 110 may be configured to receive data from the second sensor 58 that is indicative of the soil condition aft of each shank assembly 60 relative to the direction of travel 14 of the agricultural implement 10. Furthermore, the computing system 110 may be communicatively coupled to the engine 24 and/or the transmission 26 of the agricultural vehicle 12 via the communicative link 102. In this respect, the computing system 110 may be configured to control the operation of the engine 24 and/or the transmission 26 to adjust the ground speed at which the agricultural implement 10 travels across the field. In addition, the computing system 110 may be communicatively coupled to any other suitable components of the agricultural implement 10, the agricultural vehicle 12, and/or the system 100.

In general, the computing system 110 may comprise any suitable processor-based device known in the art, such as a given controller or computing device or any suitable combination of controllers or computing devices. Thus, in several embodiments, the computing system 110 may include one or more processor(s) 112 and associated memory device(s) 114 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 114 of the computing system 110 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 114 may generally be configured to store suitable computer-readable instructions that, when implemented by the processor(s) 112, configure the computing system 110 to perform various computer-implemented functions, such as one or more aspects of the methods and algorithms that will be described herein. In addition, the computing system 110 may also include various other suitable components, such as a communications circuit or module, one or more input/output channels, a data/control bus and/or the like.

It should be appreciated that the computing system 110 may correspond to an existing computing system(s) of the agricultural implement 10 and/or the agricultural vehicle 12, itself, or the computing system 110 may correspond to a separate processing device. For instance, in one embodiment, the computing system 110 may form all or part of a separate plug-in module that may be installed in association with the agricultural implement 10 and/or the agricultural vehicle 12 to allow for the disclosed systems to be implemented without requiring additional software to be uploaded onto existing control devices of the agricultural implement 10 and/or the agricultural vehicle 12.

Furthermore, it should also be appreciated that the functions of the computing system 110 may be performed by a single processor-based device or may be distributed across any number of processor-based devices, in which instance such devices may be considered to form part of the computing system 110. For instance, the functions of the computing system 110 may be distributed across multiple application-specific controllers or computing devices, such as a navigation controller, an engine computing controller, a transmission controller, an implement controller and/or the like.

In addition, the system 100 may also include a user interface 120. More specifically, the user interface 120 may be configured to provide feedback, such as feedback associated with the location(s) of each shank assembly 60 with a failed shear pin 90, to the operator. As such, the user interface 120 may include one or more feedback devices (not shown), such as display screens, speakers, warning lights, and/or the like, which are configured to provide feedback from the computing system 110 to the operator. As such, the user interface 120 may, in turn, be communicatively coupled to the computing system 110 via the communicative link 102 to permit the feedback to be transmitted from the computing system 110 to the user interface 120. Furthermore, some embodiments of the user interface 120 may include one or more input devices, such as touchscreens, keypads, touchpads, knobs, buttons, sliders, switches, mice, microphones, and/or the like, which are configured to receive inputs from the operator. In one embodiment, the user interface 120 may be mounted or otherwise positioned within the operator's cab 22 of the agricultural vehicle 12. However, in alternative embodiments, the user interface 120 may mounted at any other suitable location.

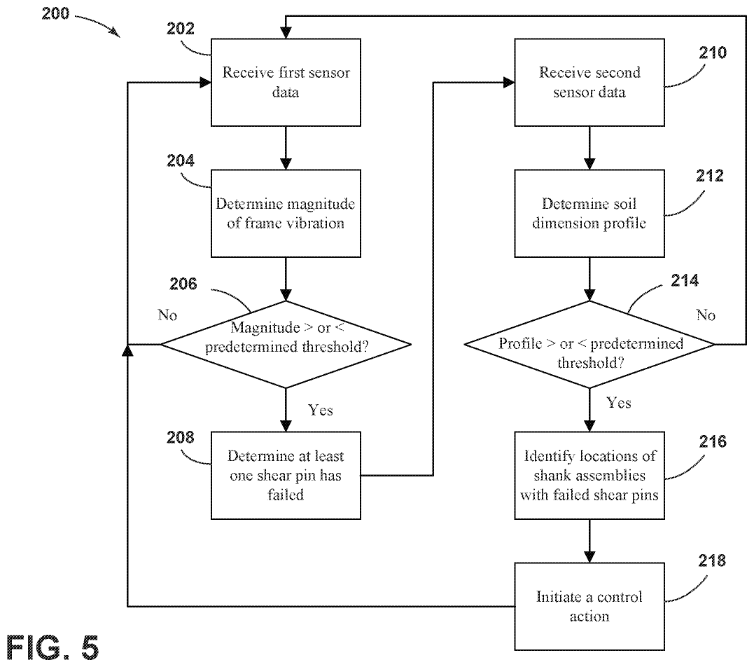

Referring now to FIG. 5, a flow diagram of one embodiment of control logic 200 that may be executed by the computing system 110 (or any other suitable computing system) for identifying broken shear pins on an agricultural implement is illustrated in accordance with aspects of the present subject matter. Specifically, the control logic 200 shown in FIG. 5 is representative of steps of one embodiment of an algorithm that can be executed to identify broken shear pins on an agricultural implement. Thus, in several embodiments, the control logic 200 may be advantageously utilized in association with a system installed on or forming part of an agricultural implement to allow for real-time identification of broken shear pins of the implement without requiring substantial computing resources and/or processing time. However, in other embodiments, the control logic 200 may be used in association with any other suitable system, application, and/or the like for identifying broken shear pins of an agricultural implement.

As shown in FIG. 5, at (202), the control logic 200 includes receiving first sensor data indicative of vibrations of a frame of an agricultural implement. Specifically, as mentioned above, in several embodiments, the computing system 110 may be communicatively coupled to the first sensor(s) 56 via the communicative link 102. In this respect, as the agricultural implement/vehicle 10/12 travels across the field to perform an agricultural operation thereon, the computing system 110 may receive data from the first sensor(s) 56. Such data may, in turn, be indicative of vibrations of the implement frame 28 of the agricultural implement 10.

Additionally, as shown in FIG. 5, at (204), the control logic 200 includes determining a magnitude of the vibrations of the frame of the agricultural implement based on the first sensor data. In this respect, the computing system 110 may be configured to determine a magnitude of the vibrations, such as an amplitude of the vibrations, within the implement frame 28 (e.g., within the structural frame member 38).

Furthermore, as shown in FIG. 5, at (206), the control logic 200 includes comparing the magnitude of the vibrations of the frame to a predetermined vibration threshold value. During undesired operating conditions, when the shear pin(s) 90 of the shank assembly(ies) 60 has partially or completely failed, the vibrations created within the implement frame 28, such as the structural frame member 38, may increase above a selected or predetermined vibration threshold value relative to the vibrations created during desired/normal operating conditions (e.g., when the shear pin(s) 90 has not failed). As such, the computing system 110 may be configured to compare the magnitude of the vibrations, such as the amplitude of the vibrations, created within the structural frame member 38A to the predetermined vibration threshold value, such as a predetermined amplitude threshold value. The predetermined vibration threshold value (e.g., predetermined amplitude threshold value) may be a minimum value indicative of one or more failed shear pins 90. When the magnitude of the vibrations of the implement frame 28 exceeds the predetermined vibrations threshold, the control logic 200 proceeds to (208). When the magnitude of the vibrations of the implement frame 28 falls below the predetermined vibrations threshold, the control logic 200 returns to (202).

Moreover, as shown in FIG. 5, at (208), the control logic 200 includes determining that the shear pin of at least one ground-engaging shank assembly has failed when the magnitude of the vibrations of the frame exceeds the predetermined vibration threshold value. As such, the computing system 110 may be configured to determine that one or more shear pins 90 have failed when the magnitude of vibrations (e.g., amplitude) determined at (204) exceeds the predetermined vibration (e.g., amplitude) threshold.

Additionally, as shown in FIG. 5, at (210), the control logic 200 includes receiving second sensor data indicative of a soil condition aft of a shank portion of each ground-engaging shank assembly relative to a direction of travel of the agricultural implement. Specifically, as mentioned above, in several embodiments, the computing system 110 may be communicatively coupled to the second sensor(s) 58 via the communicative link 102. In this respect, as the agricultural implement/vehicle 10/12 travels across the field to perform an agricultural operation thereon, the computing system 110 may receive data from the second sensor(s) 58. Such data may, in turn, be indicative of the soil condition aft of the shank 50 of each shank assembly 60 relative to the direction of travel 14 of the agricultural implement 10. The data received from the second sensor(s) 58 is used by the computing system 110 to determine the location of each shank assembly 60 with a failed shear pin 90.

Furthermore, as shown in FIG. 5, at (212), the control logic 200 includes determining a soil dimension profile aft of the shank portion of each ground-engaging shank assembly relative to the direction of travel of the agricultural implement based on the second sensor data. During desired/normal operating conditions, when the shear pins 90 of the shank assemblies 60 have not partially or completely failed, each shank 50 may till or remove a surface layer of the soil at a selected or desired soil dimension profile (e.g., depth). However, when one or more shear pins 90 of the shank assemblies 60 have failed, the respective shank(s) 50 may not till or remove the surface layer of the soil at the selected or desired soil dimension profile (e.g., depth). In this respect, the computing system 110 may be configured to determine a soil dimension profile, such as the depth of tilled soil (or lack thereof), aft of each shank 50.

Moreover, as shown in FIG. 5, at (214), the control logic 200 includes comparing the soil dimension profile to a predetermined soil dimension profile threshold for each ground-engaging shank assembly. As such, the computing system 110 may be configured to compare the soil dimension profile, such as the depth of the tilled or removed soil, to the predetermined soil dimension profile threshold, such as a predetermined depth threshold. The predetermined soil dimension profile threshold may be a depth indicative untilled or minimally tilled soil as a result of one or more of the shanks 50 not engaging or minimally engaging the soil due to one or more failed shear pins 90 of the shank assemblies 60.

Additionally, as shown in FIG. 5, at (216), the control logic 200 includes identifying the location of each ground-engaging shank assembly with a failed shear pin when the soil dimension profile falls below the predetermined soil dimension profile threshold. As such, the computing system 110 may be configured to identify the location of each shank assembly 60 with a failed shear pin 90 when the soil dimension profile, such as the depth, falls below the predetermined soil dimension profile threshold. For example, the computing system 110 may access a look-up table stored within its memory device(s) 114 that correlates each soil dimension profile to each shank assembly 60. As such, the computing system 110 may be configured to identify the location of each shank assembly 60 with a failed shear pin 90 by determining the shank assembly(ies) 60 that correlate to the soil dimension profile(s) that falls below the predetermined soil dimension profile threshold.

Furthermore, as shown in FIG. 5, at (218), the control logic 200 includes initiating a control action when the location of at least one ground-engaging shank assembly with a failed shear pin is identified. Specifically, in one embodiment, the computing system 110 may be configured to provide a notification to an operator of the agricultural implement/vehicle 10/12 of the location of the shank assembly(ies) 60 with a failed shear pin 90. Specifically, the computing system 110 may be configured to transmit instructions to the user interface 120 (e.g., via the communicative link 102) instructing the user interface 120 to provide a notification to the operator of the agricultural implement/vehicle 10/12 (e.g., by causing a visual notification or indicator to be presented to the operator) indicating the location(s) of the shank assembly(ies) 60 with a failed shear pin 90.

Alternatively, or additionally, at (218), the computing system 110 may be configured to automatically adjust the ground speed at which the agricultural implement/vehicle 10/12 is traveling across the field when the location(s) of the shank assembly(ies) 60 with a broken shear pin 90 is identified. Specifically, the computing system 110 may be configured to transmit instructions to the engine 24 and/or the transmission 26 (e.g., via the communicative link 102) instructing the engine 24 and/or the transmission 26 to adjust their operation. For example, the computing system 110 may instruct the engine 24 to vary its power output and/or the transmission 26 to upshift or downshift to increase or decrease the ground speed and/or stopping movement of the agricultural implement/vehicle 10/12. However, in alternative embodiments, the computing system 110 may be configured to transmit instructions to any other suitable components (e.g., braking actuators) of the agricultural vehicle 12 and/or the agricultural implement 10 such that the ground speed of the agricultural implement/vehicle 10/12 is adjusted. Furthermore, it should be appreciated that any other suitable parameter(s) the agricultural implement 10 and/or the agricultural vehicle 12 may be adjusted when the location(s) of the shank assembly(ies) 60 with a broken shear pin 90 is identified. Upon completion of (218), the control logic 200 returns to (202).

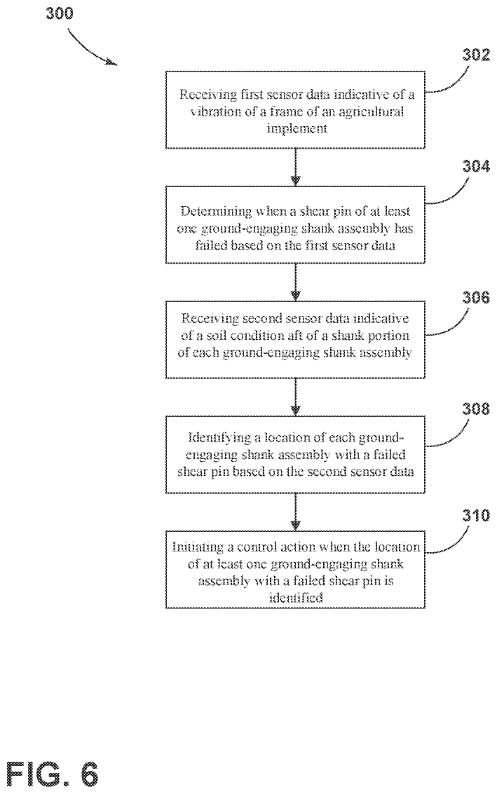

Referring now to FIG. 6, a flow diagram of one embodiment of a method 300 for identifying broken shear pins on an agricultural implement is illustrated in accordance with aspects of the present subject matter. In general, the method 300 will be described herein with reference to the agricultural implement 10 and the agricultural vehicle 12 shown in FIGS. 1-3 and the system 100 described with reference to FIGS. 4 and 5. However, it should be appreciated that the disclosed method 300 may be implemented with agricultural vehicles and/or implements having any other suitable configurations and/or within systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 6, at (302), the method 300 may include receiving, with a computing system, first sensor data indicative of vibrations of a frame of an agricultural implement. For instance, as indicated above, the computing system 110 may be communicatively coupled to the first sensor 56 configured to generate data indicative of vibrations of the implement frame 28, such as the structural frame member 38A, of the agricultural implement 10. As such, the computing system 110 may be configured to receive the first sensor data indicative of the vibrations of the implement frame 28 of the agricultural implement 10.

Additionally, at (304), the method 300 may include determining, with the computing system, when a shear pin of at least one ground-engaging shank assembly of the agricultural implement has failed based on the received first sensor data. As such, the computing system 110 may be configured to determine when the shear pin 90 of at least one shank assembly 60 of the agricultural implement 10 has failed based on the data received from the first sensor(s) 56.

Moreover, at (306), the method 300 may include receiving, with the computing system, second sensor data indicative of a soil condition aft of a shank portion of each ground-engaging shank assembly relative to a direction of travel of the agricultural implement. For instance, as indicated above, the computing system 110 may be communicatively coupled to the second sensor 58 configured to generate data indicative of a soil condition aft of the shank 50 of each shank assembly 60 relative to the direction of travel 14 of the agricultural implement 10. As such, the computing system 110 may be configured to receive the second sensor data indicative of the soil condition aft of the shank 50 of each shank assembly 60 relative to the direction of travel 14 of the agricultural implement 10.

Furthermore, at (308), the method 300 may include identifying, with the computing system, a location of each ground-engaging shank assembly with a failed shear pin based on the second sensor data. As such, the computing system 110 may be configured to identify a location of each shank assembly 60 with a failed shear pin 90 based on the data from the second sensor(s) 58.

Additionally, at (310), the method 300 may include initiating, with the computing system, a control action when the location of at least one ground-engaging shank assembly with a failed shear pin is identified. For instance, as indicated above, the computing system 110 may be communicatively coupled to the user interface 120 and the engine 24 and/or the transmission 26 of the agricultural vehicle 12. As such, the computing system 110 may be configured to notify the operator of the agricultural implement 12 via the user interface 120 of the location of each shank assembly 60 with a failed shear pin 90. Furthermore, the computing system 110 may be configured to slow or halt movement of the agricultural vehicle 12, and thus the agricultural implement 10, by controlling an operation of the engine 24 and/or transmission 26 of the agricultural vehicle 12.

It is to be understood that the steps of the control logic 200 and the method 300 are performed by the computing system 110 upon loading and executing software code or instructions which are tangibly stored on one or more tangible computer readable media, such as one or more magnetic media (e.g., a computer hard drive(s)), one or more optical media (e.g., an optical disc(s)), solid-state memory (e.g., flash memory), and/or other storage media known in the art. Thus, any of the functionality performed by the computing system 110 described herein, such as the control logic 200 and the method 300, is implemented in software code or instructions which are tangibly stored on one or more tangible computer readable media. The computing system 110 loads the software code or instructions via a direct interface with the one or more computer readable media or via a wired and/or wireless network. Upon loading and executing such software code or instructions by the computing system 110, the computing system 110 may perform any of the functionality of the computing system 108 described herein, including any steps of the control logic 200 and the method 300 described herein.

The term “software code” or “code” used herein refers to any instructions or set of instructions that influence the operation of a computing system, such as one or more computers or one or more controllers. They may exist in a computer-executable form, such as machine code, which is the set of instructions and data directly executed by a computing system's central processing unit(s) or by a controller(s), a human-understandable form, such as source code, which may be compiled in order to be executed by a computing system's central processing unit(s) or by a controller(s), or an intermediate form, such as object code, which is produced by a compiler. As used herein, the term “software code” or “code” also includes any human-understandable computer instructions or set of instructions (e.g., a script), that may be executed on the fly with the aid of an interpreter executed by a computing system's central processing unit(s) or by a controller(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system for identifying broken shear pins on an agricultural implement, the system comprising:
a plurality of ground-engaging shank assemblies, each ground-engaging shank assembly comprising:
an attachment structure coupling the ground-engaging shank assembly to a frame of an agricultural implement;
a shank portion pivotably coupled to the attachment structure at a pivot joint; and
a shear pin at least partially extending through the attachment structure and the shank portion to prevent pivoting of the shank portion about the pivot joint;
a first sensor configured to generate data indicative of vibrations of the frame of the agricultural implement;
a second sensor configured to generate data indicative of a soil condition aft of the shank portion of each ground-engaging shank assembly relative to a direction of travel of the agricultural implement; and
a computing system communicatively coupled to the first sensor and the second sensor, the computing system configured to:
determine when the shear pin of at least one ground-engaging shank assembly has failed based on the first sensor data; and
after determining that the shear pin of the at least one ground-engaging shank assembly has failed, identify a location of each ground-engaging shank assembly with a failed shear pin based on the second sensor data.

2. The system of claim 1, wherein, when determining when the shear pin of the at least one ground-engaging shank assembly has failed based on the first sensor data, the computing system is configured to:
determine a magnitude of the vibrations of the frame of the agricultural implement based on the first sensor data;
compare the determined magnitude of the vibrations of the frame to a predetermined vibration threshold value; and
determine that the shear pin of at least one ground-engaging shank assembly has failed when the determined magnitude of the vibrations of the frame exceeds the predetermined vibration threshold value.

3. The system of claim 1, wherein, when determining when the shear pin of the at least one ground-engaging shank assembly has failed based on the first sensor data, the computing system is configured to:
determine an amplitude of the vibrations of the frame of the agricultural implement based on the first sensor data;
compare the determined amplitude of the vibrations of the frame to a predetermined amplitude threshold value; and
determine that the shear pin of at least one ground-engaging shank assembly has failed when the determined amplitude of the vibrations of the frame exceeds the predetermined amplitude threshold value.

4. The system of claim 1, wherein, when identifying the location of each ground-engaging shank assembly with a failed shear pin based on the second sensor data, the computing system is configured to:
determine a soil dimension profile aft of the shank portion of each ground-engaging shank assembly relative to the direction of travel of the agricultural implement based on the second sensor data;
compare the soil dimension profile to a predetermined soil dimension profile for each ground-engaging shank assembly; and
identify the location of each ground-engaging shank assembly with a failed shear pin when the soil dimension profile threshold falls below from the predetermined soil dimension profile threshold.

5. The system of claim 1, wherein the computing system is further configured to initiate a control action when the location of at least one ground-engaging shank assembly with a failed shear pin is identified.

6. The system of claim 5, wherein the control action comprises notifying an operator of the agricultural implement of the location of each ground-engaging shank assembly with a failed shear pin.

7. The system of claim 1, wherein the first sensor comprises an accelerometer.

8. The system of claim 1, wherein the second sensor comprises a vision-based sensor.

9. An agricultural implement, comprising:
a frame;
a plurality of ground-engaging shank assemblies supported relative to the frame, each ground-engaging shank assembly comprising:
an attachment structure coupling the ground-engaging shank assembly to a frame of an agricultural implement;
a shank portion pivotably coupled to the attachment structure at a pivot joint;
a shear pin at least partially extending through the attachment structure and the shank portion to prevent pivoting of the shank portion about the pivot joint; and
a biasing element coupled between the frame and the attachment structure, the biasing element being configured to bias the shank portion towards a ground-engaging position;
a first sensor configured to generate data indicative of vibrations of the frame of the agricultural implement;
a second sensor configured to generate data indicative of a soil condition aft of the shank portion of each ground-engaging shank assembly relative to a direction of travel of the agricultural implement; and
a computing system communicatively coupled to the first sensor and the second sensor, the computing system configured to:
determine when the shear pin of at least one ground-engaging shank assembly has failed based on the first sensor data; and
after determining that the shear pin of the at least one ground-engaging shank assembly has failed, identify a location of at least one ground-engaging shank assembly with a failed shear pin based on the data generated by the second sensor.

10. The agricultural implement of claim 9, wherein, when determining that the shear pin of at least one ground-engaging shank assembly has failed based on the first sensor data, the computing system is configured to:
determine a magnitude of the vibrations of the frame of the agricultural implement based on the first sensor data;
compare the magnitude of the vibrations of the frame to a predetermined vibration threshold value; and
determine that the shear pin of at least one ground-engaging shank assembly has failed when the magnitude of the vibrations of the frame exceeds the predetermined vibration threshold value.

11. The agricultural implement of claim 9, wherein, when determining that the shear pin of at least one ground-engaging shank assembly has failed based on the first sensor data, the computing system is configured to:
determine an amplitude of the vibrations of the frame of the agricultural implement based on the first sensor data;
compare the amplitude of the vibrations of the frame to a predetermined amplitude threshold value; and
determine that the shear pin of at least one ground-engaging shank assembly has failed when the amplitude of the vibrations of the frame exceeds the predetermined amplitude threshold value.

12. The agricultural implement of claim 9, wherein, when identifying the location of each ground-engaging shank assembly with a failed shear pin based on the second sensor data, the computing system is configured to:
determine a soil dimension profile aft of the shank portion of each ground-engaging shank assembly relative to the direction of travel of the agricultural implement based on the second sensor data;
compare the soil dimension profile to a predetermined soil dimension profile threshold for each ground-engaging shank assembly; and
identify the location of each ground-engaging shank assembly with a failed shear pin when the soil dimension profile falls below the predetermined soil dimension profile threshold.

13. The agricultural implement of claim 9, wherein the computing system is further configured to initiate a control action when the location of at least one ground-engaging shank assembly with a failed shear pin is identified.

14. The agricultural implement of claim 13, wherein the control action comprises notifying an operator of the agricultural implement of the location of each ground-engaging shank assembly with a failed shear pin.

15. The agricultural implement of claim 9, wherein the first sensor comprises an accelerometer.

16. The agricultural implement of claim 9, wherein the second sensor comprises a vision-based sensor.

17. A method for identifying broken shear pins on an agricultural implement, the method comprising:
receiving, with a computing system, first sensor data indicative of vibrations of a frame of an agricultural implement;
determining, with the computing system, when a shear pin of at least one ground-engaging shank assembly of the agricultural implement has failed based on the received first sensor data;
receiving, with the computing system, second sensor data indicative of a soil condition aft of a shank portion of each ground-engaging shank assembly relative to a direction of travel of the agricultural implement;
identifying, with the computing system, a location of each ground-engaging shank assembly with a failed shear pin based on the second sensor data; and
initiating, with the computing system, a control action when the location of at least one ground-engaging shank assembly with a failed shear pin is identified.

18. The method of claim 17, wherein, when determining that the shear pin of at least one ground-engaging shank assembly has failed based on the first sensor data, the method further comprises:
determining, with the computing system, a magnitude of the vibrations of the frame of the agricultural implement based on the first sensor data;
comparing, with the computing system, the magnitude of the vibrations of the frame to a predetermined vibration threshold value; and
determining, with the computing system, that the shear pin of at least one ground-engaging shank assembly has failed when the magnitude of the vibrations of the frame exceeds the predetermined vibration threshold value.

19. The method of claim 17, wherein, when identifying the location of each ground-engaging shank assembly with a failed shear pin based on the second sensor data, the method further comprises:
determining, with the computing system, a soil dimension profile aft of the shank portion of each ground-engaging shank assembly relative to the direction of travel of the agricultural implement based on the second sensor data;
comparing, with the computing system, the soil dimension profile to a predetermined soil dimension profile threshold for each ground-engaging shank assembly; and
identifying, with the computing system, the location of each ground-engaging shank assembly with a failed shear pin when the soil dimension profile falls below the predetermined soil dimension profile threshold.

20. The method of claim 17, wherein the control action comprises:
notifying, with the computing system, an operator of the agricultural implement of the location of each ground-engaging shank assembly with a failed shear pin.
